(19) United States
(12) Patent Application Publication
(10) Pub. No.: US 2025/0215245 A1
(43) Pub. Date: Jul. 3, 2025

(54) Coating composition to prevent Automobile Tire slip, Truck Tire slip, Footwear slip in Snow and Icy road conditions

(71) Applicant: Ayesha Khan, Villa Park, IL (US)

(72) Inventor: Ayesha Khan, Villa Park, IL (US)

(21) Appl. No.: 18/401,417

(22) Filed: Dec. 30, 2023

(51) Int. Cl. C09D 7/61; C08K 3/04; C09D 5/00; C09D 7/40

(52) U.S. Cl. CPC C09D 7/61; C09D 5/00; C09D 7/67; C09D 7/68; C09D 7/69; C08K 3/04; C08K 2201/005; C08K 2201/011

(57) ABSTRACT

Disclosed herein are embodiments of a method of making a coating composition for Automobile Tires, Truck Tires and footwear to prevent slip in Snow and/or Icy weather conditions. The method includes a polymer base and abrasive particles. The amount of abrasive particles in the coating could range from 0.001 up to 90 percent by weight. Also discussed herein are the embodiments of related compositions and/or method of using the coating on different substrates.

U.S. Patent Documents

| | | |
|---|---|---|
| 2,819,681 | January 1958 | Luvisi |
| 3,878,147 | April 1975 | Craven |
| 2,739,135 | March 1956 | Delang |
| 3,350,342 | October 1967 | Begley |
| 3,475,205 | October 1969 | Byers |
| 3,600,329 | August 1971 | Enriquez |
| 3,652,720 | March 1972 | Wright |
| 4,019,912 | April 1977 | Augustin |
| 4,990,188 | February 1991 | Micek et al. |
| 5,456,744 | October 1995 | Fattor |

### FIELD

Embodiments of the present disclosure relate to coating compositions for Automobile Tire surface or Bottom surface of the Footwear to prevent slip during Icy road conditions

### DETAILED DESCRIPTION

### A—Method of Making a Automobile Tire and Footwear/Shoe Non Skid Coating Composition to Prevent Slip on Icy Road Conditions

### A.1 Powdered Abrasive Composition Component

A powdered Abrasive composition component according to the present disclosure includes synthetic diamond particles, synthetic diamond dispersion in polymer matrix. Synthetic diamond mixed in polymer coating, paint, adhesive, polymer composite, polymer molding to help prevent the slip of Automobile tires and Shoe (Foot wear) in Icy road conditions. The diamond particles amount in the coating or polymer matrix composition can be from 0.001 to 95 percent by weight.

Synthetic diamond particles include monocrystalline and Polycrystalline diamond particles, with or without other abrasive particles. Other abrasive particles can be Boron Nitride, Boron Carbide, Silicon Nitride, Silicon Carbide. The abrasive component comprises particles with hardness ranging from 3.4 Mohs to 10 Mohs.

### A.2 Base Polymer Component

A base polymer component according to the present disclosure can include a single component or two components or mixture of different polymers. The polymer can include thermoplastic and/or thermoset polymer. The base polymer component includes Polyurethane, block copolymer of Polyurethane, Graft Copolymer of Polyurethane with other polymers, Epoxy resin with Amine hardener, Epoxy resin with Amine and silane, Phenolic resin with crosslinker, Epoxy resin Novolac, Epoxy resin with phenolic resin and catalyst, Melamine formaldehyde

Single component polymers include self curing polymers such as Ethyl Cyanoacrylate, Methyl Cyanoacrylate.

A base polymer component includes polymers such as polyurethane, Acrylic Resins such as Polymethylmethacrylate, Ethyl Methacrylate, Vinyl resins, Polybutadiene, Natural rubber, Novolac, Cresol, Epoxy resin one component and Two component adhesive such as Epoxy resin with Amine catalyst.

A base polymer component can also be a Solvent based or Water based or UV curing one component or two component pressure sensitive adhesive (PSA). A base polymer could be hot melt adhesive composition, A base polymer could be reactive hotmelt adhesive composition.

A base polymer component can be from 0.5 percent by weight to 97 percent by weight

### A.3 Solvent Component

The solvent component of the composition consists of any one or combination of DI water, Alcohols, Esters, Ketones, Aromatics, Hydrocarbons, Glycols, Glycol Ethers, Alkane. The Alcohol solvent can be nPropanol, Isopropanol, Ethanol, Butanol, Isobutanol. The Ester solvent consists of nPropyl Acetate, Ethyl Acetate. The Ketone solvent includes Acetone, MEK, MEBK. Aromatic solvent include Toluene, Xylene. Hydrocarbon solvent include Odorless Mineral Spirit, Naphtha. Glycols include Ethylene Glycol, Propylene Glycol. Glycol Ether includes Ethylene glycol or Propylene glycol derivatives such as DPM, DPnB, PMAcetate, Butyl Carbitol. Alkane includes nHexane, Cyclohexane. The solvent component of the coating can be 0 to 50 percent by weight

### A.4 Coating Process

The coating composition can be applied by spray coating, dip coating, brush coating, roller coating, extrusion coating or the coating composition can be pour-on using a squeeze bottle over the Side walls of the Tire, Bottom or Sole of Footwear to prevent slip. Spray coating, Brush coating, Pour on the area of interest on the tire by squeeze bottle can be applied manually. The extrusion process can be applied in the Automobile Tire manufacturing process by Tire manufacturer or for the footwear industry by the footwear manufacturer. Coating process could be hot melt adhesive layer with abrasive particles applied during Tire or shoe manufacturing process, coating process could be done by flexo coater, gravure coater, flat bed or rotary screen printing, knife coater, rod coating, slot die coater, extrusion coater on to a film or polymer substrate that can be attached to the Automobile Tire, Footwear during or after manufacturing

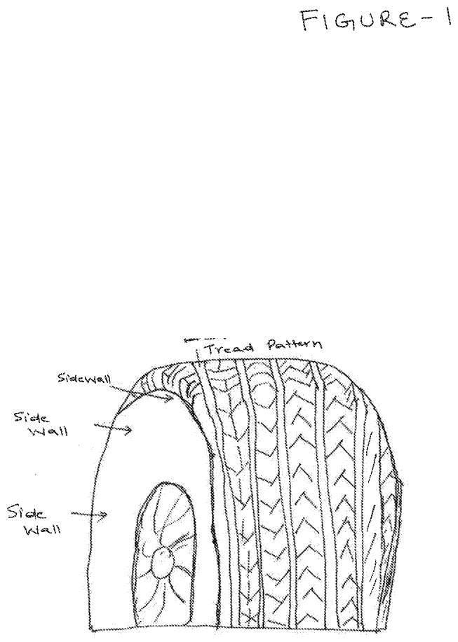

FIG. 1. Drawing shows the area of the sidewall of the Automobile Tire where the coating can be applied. FIG. 1 also shows the thread of the Tire where the coating can be applied. During the slip the coating will come into contact with road surface

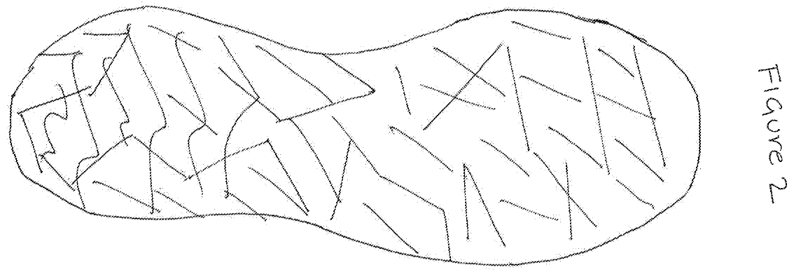

FIG. 2. Drawing shows the sole of the footwear where the coating can be applied to the bottom of the shoe

The coating, according to the embodiments of the invention, can be coated over the entire surface of the Tire.

The coating according to the embodiments of the invention can be coated over the Side Wall area of the Tire.

The above formulation specification constitutes the spirit and scope of the invention.

As used in this specification and the claims, the term “or” is generally employed in its sense including “and/or” unless the content clearly dictates otherwise.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive.

As used herein, the terms “comprises,” “includes,” “including,” or any other variation thereof, are intended to cover a non-exclusive inclusion.

What is claimed is:

1. A method of making a coating composition for non skid or non slip of the Automobile Tire, Truck Tire and Shoe (Footwear) in icy road conditions, wherein the components and method comprises of mixing a Polymer base and Abrasive particles to form a dispersion in polymer matrix wherein the amount of abrasive particles can range from 0.001% to 90% by weight of the polymer coating or composite composition.

2. The method of claim 1, wherein the abrasive particles comprise of synthetic diamond particles.

3. The method of claim 2, wherein the Synthetic diamond particles comprises of Monocrystalline or Polycrystalline diamond or mixture of the Monocrystalline and Polycrystalline diamond.

4. The method of claim 2, wherein the synthetic diamond particles comprises of diamond with particle size ranging from 1 nm to 100 microns or higher.

5. The method of claim 1, wherein the abrasive particles could also consists of abrasive particles such as CBN (Cubic Boron Nitride), Boron Carbide, Aluminum oxide, Silicon Dioxide, Silicon carbide, Titanium dioxide, Tungsten Carbide, Silicon Nitride, Gallium Nitride along with diamond particles or without diamond particles.

6. The method of claim 1, wherein the abrasive particle hardness range from 3.4 to 10 on the MOHS scale of hardness.

7. The method of claim 1, wherein the base polymer can be a thermoplastic polymer or thermoset polymer, solid polymer or emulsion polymer or a polymer solution in any organic solvent or polymer with plasticizer or polymer with additives.

8. The method of claim 1, wherein the coating can be a Paint with pigments or dyes, Ink with pigment or dye, Clear coating, Pressure sensitive Adhesive, hotmelt adhesive, reactive hotmelt adhesive, UV cured adhesive, Composite coating, 3D printed thermoplastic or 3D printed thermoset polymer with abrasive particles cured with UV and/or heat. The coating can be a solvent based one component that comprises of the coating composition that dries by solvent evaporation or two component cured that cures by crosslinking by a curing agent or a catalyst or a crosslinker or UV coating that dries or hardens or cures by exposure to UV radiation. UV light comprised of the mix of the UVA, UVB, UVC wavelengths or a Water based coating system that dries by polymer emulsion coalescing or a solid polymer with abrasive extruded on to the substrate (During Tire manufacturing, Shoe manufacturing) or Articles made by 3D printed with polymer matrix with abrasive particles, hotmelt adhesive with abrasive particles include diamond particles, reactive hotmelt adhesive with abrasive particles include diamond particles.

9. The method of claim 1, wherein the polymer coating could be two component system with curing agent, dual component system cured with heat cured or ambient cured or UV cured or Amine functional (—NH2) or Hydroxyl groups (—OH) or Acid functional (—COOH) catalyst cured

10. The method of claim 1, wherein the coating could have a plasticizer comprises of a group that can be Phthalate, Adipate, Citrate, Benzoate or Any organic acid ester, Gamma Butyrolactone (GBL), epoxidized soybean oil.

11. The method of claim 1, wherein the base polymer component comprises a base polymer selected from the group consisting of polymers that are solvent soluble thermoplastic Polymer or solvent soluble pressure sensitive adhesive or an Aqueous Emulsion or water based pressure sensitive adhesive, Oligomer and monomer cured by radiation or UV cured pressure sensitive adhesive or Self curing Monomer or Oligomer once exposed to the air such as Ethyl Cyanoacrylate or Methyl Cyanoacrylate or a paint or ink with colorants and abrasive particles or a clear coating with abrasive particles that can be applied by a brush or a spray coater or roller coater or by extrusion coater or slot die coater or rod coater or Air knife coater or a dip coat or simply pour on and dry or cure over the surface of the Tire or Footwear.

12. The method of claim 1, wherein the polymer with Abrasive particle coating can be sprayed onto the substrate such as Automobile tire, bottom of the footwear/shoe or onto a film that could be attached to the Tire or Shoe by spray coating or flexo, gravure, screen coating methods, digital printing or coating methods such as continuous or drop on demand methods, extrusion coating, brush or roller coating or pour on or spray or dip coating or mix polymer and abrasive to use 3D printing method.

13. The method of claim 1, wherein the polymer with Abrasive particle coating can be applied onto the mat made using plastic or rubber or metal, that could be used to get tire traction for a car or truck stuck in snow

14. The method of claim 1, wherein the coating composition comprises a polymer or more than one polymer, combination of polymers such as Polyurethane, polybutadiene, natural and synthetic rubber, Acrylic copolymers, Rosin-esters such as Fumarated Rosin Ester and Maleated (Maleic Acid/Anhydride ester) Rosin ester, Polyketones, polybutylene, PDMS (Polydimethylsiloxane), polymethylmethacrylate, poly methyl methacrylate-butyl acrylate copolymers, SEBS (Styrene-Ethylene-Butylene-Styrene) elastomer, Styrene-Butadiene copolymer, Poly (Styrene-dimethylsiloxane) block copolymers, Styrene maleic Anhydride (SMA) resins, Polyvinyl chloride, Polyvinyl Alcohol, polyamide resin, Vinyl resins include Vinyl Chloride-Vinyl Acetate copolymers such as VMCH, VAGH, VYHH, VAGD, VMCC, VMCA, VYNS-3 resins, Epoxy resin, Epoxy Novolac resin, Melamine formaldehyde, Phenolic resins, radiation curable polymers, thermally cured polymers such as wide variety of Acrylates (Epoxy acrylates, Urethane Acrylates, Polybutadiene acrylate, Epoxy Novolac acrylate).

15. The method of claim 1, wherein the polymer could be thermoset two component chemistry comprise of Epoxy resin with Amine catalyst or Polyurethane with catalyst, epoxy novolac or epoxy-phenol formaldehyde or Phenol formaldehyde crosslinked with catalyst.

16. The method of claim 1, wherein the coating comprises of Amine or mixture of amines in case of Epoxy resin, polyol, DMDEE in case of Polyurethane or Silane or Titanate cross linker in case of polymer with —COOH, —OH, —CHO, —C═O functionality present on the polymer.

17. The method of claim 1, wherein the coating can have a DI water or organic solvent or combination of organic solvents that can be from a group of Alcohols or Esters or Glycol Ethers or Ketones or Hydrocarbons or mixture of any group or Monomer, Oligomer in case of radiation curable coating.

18. The method of claim 1, wherein the polymer coating can be a paint, coating, adhesive, film, rigid plastic, 3D printed thermoplastic or 3D printed thermoset polymer cured by Ambient or UV and/or thermal curing process.

19. The method of claim 1, wherein the coating method could be flexography, rotogravure, screen printed, slot die coated, extrusion coated, Air knife coated, bar coated onto another substrate such as film that could be later attached to Tire or Shoe or Any article that could be made non slip in Icy road conditions.

20. The method of claim 1, wherein the coating could consists of hygroscopic inorganic compounds such as calcium oxide, superabsorbent polymers such as but not limited to crosslinked polyacrylates, crosslinked polyacrylamides, crosslinked maleic anhydride copolymers, polyvinyl alcohol, starch acrylonitrile graft copolymers, other swellable polymers, carboxyalkyl cellulose such as carboxymethyl or ethyl cellulose, any associative thickener such as guar gum, Xanthan gum.
